(19) United States
(12) Patent Application Publication
(10) Pub. No.: US 2006/0098071 A1
(43) Pub. Date: May 11, 2006

(54) Cutting apparatus, cutting method, and printer

(75) Inventor: Tsuyoshi Tanabe, Kanagawa (JP)

Correspondence Address: BIRCH STEWART KOLASCH & BIRCH, PO BOX 747, FALLS CHURCH, VA, 22040-0747, US

(73) Assignee: FUJI PHOTO FILM CO., LTD.

(21) Appl. No.: 11/269,830

(22) Filed: Nov. 9, 2005

(30) Foreign Application Priority Data
Nov. 11, 2004 (JP) 2004-327762

(51) Int. Cl. B41J 2/01

(52) U.S. Cl. 347/101

(57) ABSTRACT

The cutting apparatus includes a conveyor for conveying a recording medium on which at least one image is recorded, a cutting section having two cutter, each cutter for cutting the recording medium in a conveying direction into a predetermined size in a width direction orthogonal to the conveying direction, the two cutter being capable of adjusting a distance between the two cutter in the width direction and a position adjuster for matching a cutting center, which is a central position in the width direction of cutting positions by the two cutter, and an image center, which is a central position in the width direction of at least one image recorded onto the recording medium. The printer includes an image forming section for recording plural images onto the recording medium and the cutting apparatus.

### BACKGROUND OF THE INVENTION

The present invention relates to cutting of a recording medium in a printer which carries out multi-image imposition or one-image imposition, and specially to a cutting apparatus and a cutting method for cutting a recording medium into individual prints and appropriately accumulating the prints in a printer which carries out multi-image imposition, and a printer utilizing the same.

In various kinds of printers such as a photographic printer, an electrophotographic printer, and an ink jet printer, multi-image imposition is known as a method for producing and outputting prints highly efficiently and at high speed.

The “multi-image imposition” means “recording a plurality of images onto one recording medium in accordance with a print size,” as disclosed in JP 10-213944 A, for example.

Because plural images can be recorded by one operation by carrying out such multi-image imposition, it is possible to output prints very efficiently.

On the other hand, in the printer that carries out the multi-image imposition, considering that a recording medium is cut image by image (print by print) after image recording is carried out so that plural images are imposed on the recording medium, and each image is output as one print, a recording medium cutting process different from that for an ordinary printer, and the trouble of accumulating the prints after the cutting, become necessary.

As disclosed in JP 10-213944 A, in order to cut a recording medium in a printer which carries out the multi-image imposition, usually, each print is cut off by cutting the recording medium in two directions by using a cutter for cutting the recording medium in a conveying direction (hereinafter referred to as y direction) and a cutter for cutting the recording medium in an x direction that is orthogonal to the y direction.

Here, in a case where the multi-image imposition is carried out, there is hardly a case where images corresponding to print sizes are recorded without unnecessary gaps therebetween onto one recording medium. Further, in recent years, a print having an image printed onto the entire surface (what is called a frameless print) is the mainstream.

In addition, in an apparatus prone to contamination of a toner and the like in image recording by electrophotography, namely contamination and the like in image recording means by an ink or the toner, in order to suppress the contamination to a minimum, it is not preferable to record an image onto the entire surface of a recording medium. That is, usually, an image is recorded while leaving a margin in a peripheral part of a recording medium.

Considering the above-mentioned point, in the apparatus that cuts a recording medium which was subjected to the multi-image imposition, it is necessary to cut at four positions in a margin in the peripheral part of the recording medium and also to cut at two positions per each clearance of the images. For example, in a case where four-image imposition is carried out, that is, two images are arranged in the x direction and two images are arranged in the y direction, it is necessary to cut the recording medium at four positions in the x direction and at four positions in the y direction. That is, it is necessary to cut the recording medium at eight positions in total. Consequently, four cutters for cutting the recording medium in the y direction that is the conveying direction are necessary in this case.

Further, it is preferable to output prints so that the prints are accumulated at one place after carrying out the cutting of such recording medium. Further in addition, in the printer that carries out production of prints per one print job such as a photographic printer, for example, it is necessary to accumulate the prints in an order of the images (what is called frame order) as well as collectively accumulating the prints per case.

### SUMMARY OF THE INVENTION

The object of the present invention is to provide a cutting apparatus with simple configuration with which a recording medium can be cut into individual prints appropriately even when the number of images to be imposed is large, the prints can be appropriately accumulated in one place, and the prints can be easily accumulated in frame order, in a printer that is capable of carrying out cutting of a recording medium with plural images imposed and requires a process different from that of ordinary printer, and a cutting method, and also to provide a printer that carries out the multi-image imposition by utilizing the cutting apparatus and the cutting method.

In order to attain the above object, the present invention provides a cutting apparatus including:

conveying means for conveying a recording medium on which at least one image is recorded;

a cutting section having two cutting means, each cutting means for cutting said recording medium in a conveying direction by said conveying means into a predetermined size in a width direction orthogonal to the conveying direction, said two cutting means being capable of adjusting a distance between said two cutting means in the width direction; and

position adjusting means for matching a cutting center, which is a central position in the width direction of two cutting positions at which cutting is carried out by said two cutting means, and an image center, which is a central position in the width direction of at least one image recorded onto said recording medium.

In the cutting apparatus of the present invention, preferably, said two cutting means are always separated from each other by a same distance with respect to a predetermined reference position in the width direction, and wherein said position adjusting means moves said conveying means in the width direction on an upstream side of said two cutting means and matches said cutting center and said image center with each other by matching said image center with said reference position.

Moreover, preferably, the cutting apparatus of the present invention further including: front end alignment means for adjusting an orientation of said recording medium in the width direction toward an upstream side of said two cutting means. In this case, preferably, said front end alignment means is a pair of conveying rollers, said pair of conveying rollers, serving also as said conveying means for conveying said recording medium, and wherein said position adjusting means matches said cutting center and said image center by moving said pair of conveying rollers in the width direction. In addition, preferably, the cutting apparatus of the present invention further including: end detecting means for detecting an end of said recording medium in the width direction, said end detecting means being provided on a downstream side of said front end alignment means, wherein said position adjusting means matches said cutting center and said image center in accordance with a detection result of by said end determining means.

Further, preferably, the cutting apparatus of the present invention further including: a second cutting section disposed A on a downstream side of said cutting means, said second cutting section cutting said recording medium in the width direction to make a length of said recording medium in the conveying direction be a predetermined length; and second conveying means for conveying said recording medium cut by said cutting section to said second cutting section. In this case, preferably, at least two image are recorded on said recording medium, said recording medium having a margin around each of said at least two image, wherein said cutting section cuts said recording medium in the conveying direction to separate said recording medium into a cut recording medium having no margin in the width direction and said predetermined size in the width direction, and an uncut recording medium that is the reminder of said recording medium and onto which at least one image is recorded, said uncut recording medium having the margin around said at least one image in the width direction, wherein said second conveying means conveys both said cut recording medium and said uncut recording medium, and wherein said cutting apparatus further comprises separating means for changing a conveying path of said uncut recording medium to a direction different from said second cutting section, said separating means being provided midway of said conveying path by said second conveying means. In addition, preferably, the cutting apparatus of the present invention further including: supplying means for supplying said cutting section with said uncut recording medium which is separated by said separating means.

Further, the present invention provides a cutting method of cutting a recording medium on which plural images are recorded into plural prints of a predetermined size, said recording medium having a margin around each of said plural images, including:

cutting said recording medium by a first cutting section in a conveying direction orthogonal to the width direction in which two or more images are arranged to separate said recording medium into a cut recording medium having no margin in the width direction and a predetermined size in a width direction, and an uncut recording medium that is the reminder of said recording medium and onto which at least one image is recorded, said uncut recording medium having the margin around said at least one image in the width direction;

conveying said cut recording medium to a second cutting section;

cutting said cut recording medium by said second cutting section in the width direction to produce said print of the predetermined size in both the conveying direction and the width direction, said print having no margin in the both directions; and

cutting said recording medium into plural prints of the predetermined size by repeating an operation until there is no uncut recording medium, said operation comprising:

supplying again said uncut recording medium to said first cutting section to cut off said cut recording medium by first second cutting section,

conveying said cut recording medium to said second cutting section, and

cutting said cut recording medium by said second cutting section in the width direction to produce said print of the predetermined size having no margin in the both directions, as well as

resupplying, if the remainder of said uncut recording medium from which said cut recording medium is cut off contains at least one image, said remainder as said uncut recording medium to said first cutting section.

In the cutting method of the present invention, preferably said recording medium is cut by said first cutting section into said cut recording medium and said uncut recording medium by cutting said recording medium into the predetermined size in the width direction while matching an image center, which is a center of one image in the width direction, with a cutting center, which is a center of a cutting position in the width direction. In addition, preferably, said first cutting section cuts said cut recording medium into the predetermined size in the width direction by setting two cutting positions that are spaced apart from each other with respect to a predetermined reference position in the width direction by the same distance and by adjusting the distance between said cutting positions, and matches said cutting center and said image center with each other by adjusting a position of said recording medium in the width direction.

Further, the present invention provides a printer including:

an image forming section for carrying out image recording by multi-image imposition to record plural images onto one recording medium by distributing said plural images in accordance with sizes of said one recording medium and a print, or image recording by one-image imposition to record an image onto said one recording medium in accordance with said sizes; and

a cutting apparatus including:
conveying means for conveying said one recording medium on which at least one image is recorded;
a cutting section having two cutting means, each cutting means for cutting said one recording medium in a conveying direction by said conveying means into a predetermined size in a width direction orthogonal to the conveying direction, said two cutting means being capable of adjusting a distance between said two cutting means in the width direction; and
position adjusting means for matching a cutting center, which is a central position in the width direction of cutting positions at which cutting is carried out by said two cutting means, and an image center, which is a central position in the width direction of at least one image recorded onto said one recording medium, wherein,

when said image recording is carried out by said multi-image imposition, said image forming section records said plural images onto said one recording medium so that said plural images are arranged in a prescribed order in a conveying direction of said one recording medium by said cutting apparatus.

According to the present invention having the configuration as described above, in the printer which is capable of carrying out the multi-image imposition for recording a plurality of images onto one recording medium and cuts the recording medium into individual prints, it is possible to appropriately cut individual prints even when the number of images imposed on the recording medium is large, with simple configuration; further, it is possible to appropriately accumulate the prints in one place; and still further, it is possible to easily accumulate the prints in image order (frame number order).

### BRIEF DESCRIPTION OF THE DRAWINGS

FIG. 1 is a conceptual diagram of one embodiment of a printer according to the present invention;

FIG. 2 is a conceptual diagram of one embodiment of multi-image imposition in the printer according to the present invention;

FIG. 3A is a conceptual diagram of a cutting unit of the printer shown in FIG. 1, and FIG. 3B is a diagram conceptually showing a top surface of one portion of the cutting unit of the printer shown in FIG. 1;

FIGS. 4A to 4H are conceptual diagrams for explaining cutting of a recording medium carried out by the cutting unit of the printer shown in FIG. 1; and

FIGS. 5A to 5F are conceptual diagrams for explaining various forms of the multi-image imposition and the cutting of the recording medium carried out by the printer shown in FIG. 1.

### DESCRIPTION OF THE PREFERRED EMBODIMENTS

Hereinafter, an explanation is made in detail to a cutting apparatus and a cutting method according to the present invention, and also to a printer according to the present invention, in accordance with preferred embodiments shown in the attached drawings.

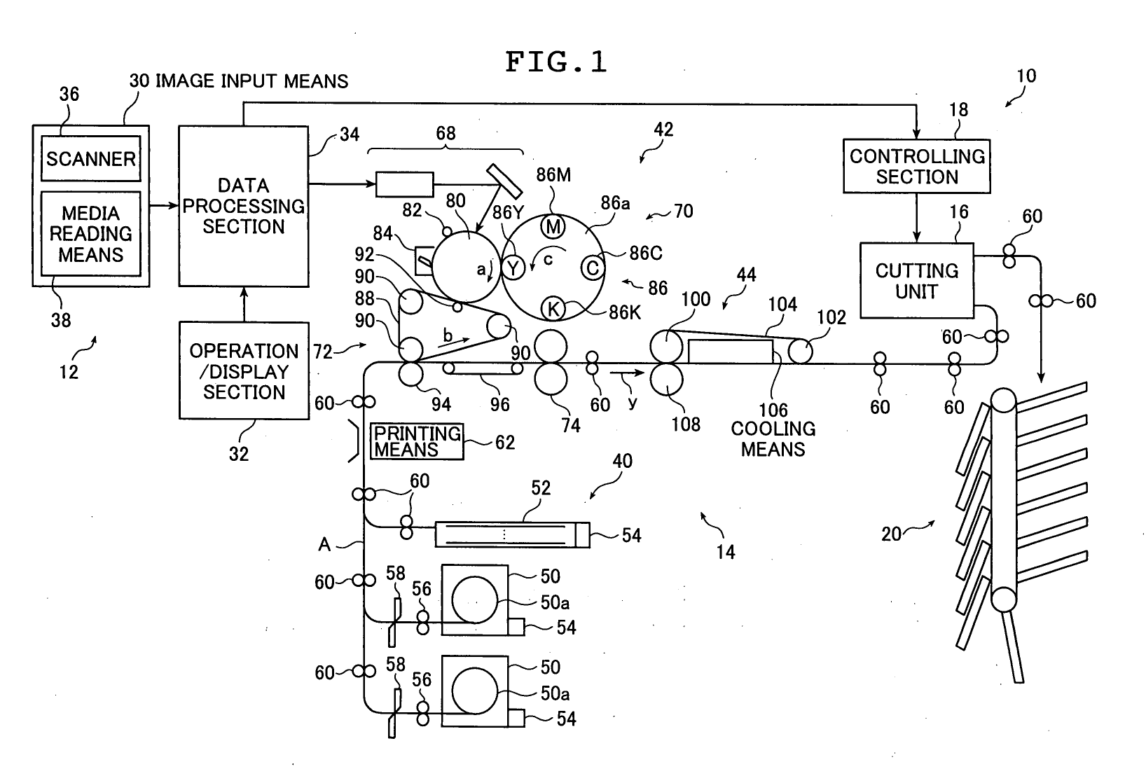

FIG. 1 shows a conceptual diagram of one embodiment of the printer according to the present invention that utilizes the cutting apparatus and the cutting method according to the present invention.

A printer 10 shown in FIG. 1 is a printer that carries out recording of a plurality of images onto one recording medium (image recording by the multi-image imposition) in accordance with a print size, or recording of one image onto one recording medium (image recording by the one-image imposition) in accordance with a print size, on the basis of the size of the recording medium to be used and the print size of the print to be outputted, that is, carries out the multi-image imposition or the one-image imposition depending upon the needs, thereafter cuts the recording medium per each print (image) into the print size, and then outputs the cut recording medium as the (finished) prints. The printer 10 is basically configured by an image input unit 12, an image forming unit 14, a cutting unit 16, a controlling unit 18 of the cutting unit 16, and a sorter 20.

The image input unit 12 is a unit for obtaining image data of an image to be recorded onto a recording medium (print) A, and carrying out necessary image processings to the image data to make the image data correspond to an image recorded by the image forming unit 14. The image input unit 12 is basically configured by image input means 30, an operation/display section 32, and a data processing section 34.

The image input means 30 is a portion for taking in image data to be recorded onto the recording medium A. In the embodiment illustrated in FIG. 1, the image input means 30 includes a scanner 36 and medium reading means 38.

The scanner 36 is a known film scanner that photoelectrically reads a projected light of a (photographic) film by a CCD sensor and the like to form digital image data.

The medium reading means 38 is reading means for reading the medium (storage medium) such as a magneto-optical recording medium (such as an MO), a small type semiconductor storage medium (such as Smart Media (registered trademark), Compact Flash (registered trademark)), magnetic recording medium (such as a flexible disk), and an optical disk (such as a CD, CD-R). In the embodiment illustrated in FIG. 1, the medium reading means 38 may be the means corresponding to one kind of medium only or may be the means corresponding to a plurality of kinds of media. In addition, a plurality of kinds of the medium reading means 38 may be provided in correspondence with the plurality of kinds of media. Further, the medium reading means 38 may be the means for directly reading the image data from an imaging device (including the medium installed on the device) such as a digital camera and a cellular phone (mobile phone) having an image pickup function.

Note that in the printer of the present invention, the image input means 30 is not limited to the scanner 36 and the medium reading means 38.

For example, it is possible to suitably utilize a reflective original scanner that photoelectrically reads an image of a reflective original, a personal computer (PC), a personal digital assistant (PDA), and the like as the image input means 30.

The image data obtained by the image input means 30 is transmitted to the data processing section 34.

The data processing section 34 is a section for generating image data corresponding to each image recorded by an image recording section 42 by carrying out necessary image processings to the supplied image data in accordance with the image data of each image, such as negative/positive conversion, gradation correction, color/density correction, color saturation correction, sharpness processing, magnification/reduction processing (electronic zooming processing), and the like.

Here, the printer 10 carries out the image imposition in accordance with a print size and the recording medium A to be used to perform image recording. In addition, the printer 10 carries out the multi-image imposition in which a plurality of images are recorded onto the recording medium A in a case where the recording medium A is of a size allowing production of a plurality of prints. For example, in a case where a print of an L size (89 mm×127 mm) that is most commonly used is produced, image recording is performed in a state where four images are imposed onto the recording medium A of an A4 size (210 mm×297 mm) to produce prints.

Therefore, the image processing section 34 generates image data corresponding to the image imposition with respect to one recording medium A. In a case of carrying out the multi-image imposition, the image processing section 34 generates image data in which the plural images are imposed at predetermined positions respectively on one recording medium A. The positional information for imposing the reproduced images of the image data generated in the image processing section 34 is transferred to the controlling section 18 of the cutting unit 16.

Here, in the printer 10, in a case where the multi-image imposition is carried out and a plurality of images are recorded in the conveying direction (y direction) of the recording medium A, the multi-image imposition is carried out so that the images are arranged in a prescribed order (what is called frame number order (file number order)) in the y direction.

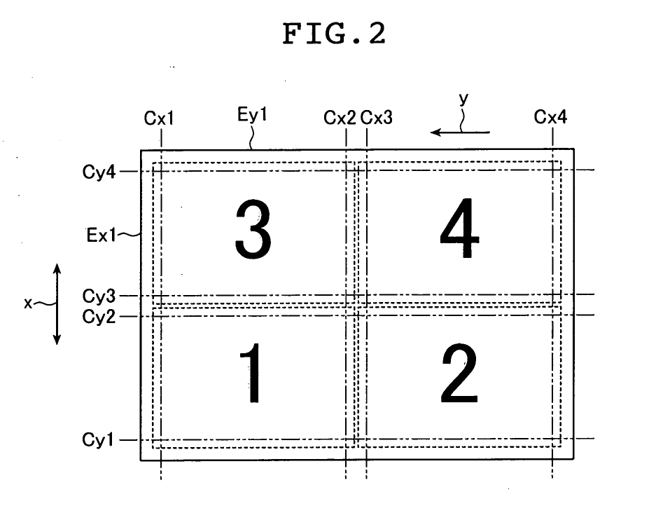

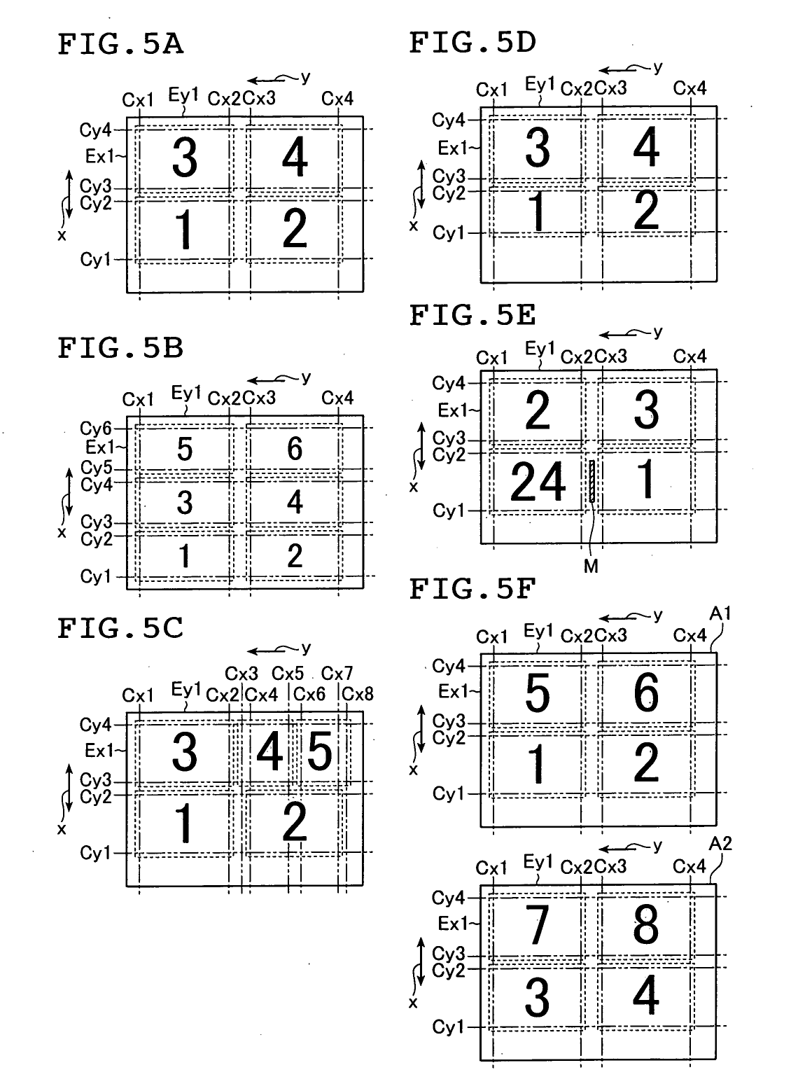

For example, in the case where four images are imposed on the recording medium A, that is, two images are imposed in the y direction and two images are imposed in the x direction that is orthogonal to the y direction (namely, a width direction of the recording medium A to be described later: that is, a main scanning direction to be described later or a direction vertical to the sheet of paper of FIG. 1), as shown in FIG. 2, the images are recorded in an order from an image 1 to an image 2 in the y direction in one of columns arranged in the x direction, and the images are recorded in an order from an image 3 to an image 4 in the y direction in the other one of the columns arranged in the x direction (for others, see FIGS. 5A to 5F). As the images 1 to 4 which are recorded on the recording medium A in four-image imposition as shown in FIG. 2, in a case of performing the multi-image imposition to record plural images onto one recording medium, there are margins generated around each image. Also, in a case of performing the one-image imposition to record one image onto one recording medium, there are margins generated around the image.

In addition, the operation/display section 32 is connected to the data processing section 34. The operation/display section 32 has a mouse, keyboard, display, and the like for carrying out an instruction as to the size of each print, the number of copies to be outputted, and the like, an instruction as to various kinds of special processings, an instruction as to color/density modification, and a confirmation of a certification image.

The image forming unit 14 is a unit for recording (reproducing) onto the recording medium A the image data obtained by the image input unit 12 as a visual image. As described above, the printer 10 carries out the image imposition in accordance with a print size and the recording medium A to be used, that is, carries out the multi-image imposition or the one-image imposition to carry out image recording. The printer 10 usually carries out the multi-image imposition.

In the illustrated embodiment, the image forming unit 14 is a unit for recording a color image onto the recording medium A by electrophotography. The image forming unit 14 is basically includes a recording medium supply section 40, an image recording section 42, and a secondary fixing section 44.

The recording medium supply section 40 (hereinafter referred to as the supply section 40) is a section for supplying the cut sheet-like recording medium A to the image recording section 42.

In the embodiment illustrated in FIG. 1, the supply section 40 is provided with two mounting subsections in each of which a magazine 50 that accommodates a recording medium roll 50a configured by winding a long recording medium is mounted, and a mounting subsection of a cassette 52 that accommodates the cut sheet-like recording medium A. In a normal case, in the respective mounting subsections for the magazine 50, the recording medium rolls 50a of sizes (width) different from each other are accommodated.

In addition, in each mounting subsection, there is disposed size detecting means 54 for detecting the size of the recording medium roll 50a accommodated in the magazine 50 and the size of the recording medium A accommodated in the cassette 52 by a DIP switch, bar-code or the like.

On a downstream side of each magazine 50 mounted to the mounting subsection (a downstream side of the recording medium A in the conveying direction), a pair of drawing rollers 56 and a cutter 58 are disposed.

The pair of drawing rollers 56 is for drawing the recording medium of the recording medium roll 50a accommodated in the magazine 50. In addition, the cutter 58 is known cutting means for cutting a sheet-like material such as a guillotine cutter.

The drawing of the recording medium from the recording medium roll 50a by the pair of drawing rollers 56 is suspended at the time when the length of the recording medium being fed on a downstream side of the cutter 58 becomes a predetermined length. Then, the cutter 58 is operated to cut the recording medium into the cut-sheet recording medium A of a predetermined size.

Both the recording medium A which was drawn out of the magazine 50 and cut into the predetermined size by the cutter 58 and the recording medium A drawn out of the cassette 52 are conveyed to the image recording section 42 by conveying roller pairs 60.

Here, there is disposed printing means 62 for recording a back print onto a back surface of a print (a surface onto which no recording of image is carried out) between two conveying roller pairs 60 disposed on an upstream side of the image recording section 42 in the conveying direction of the recording medium (hereinafter, simply referred to as upstream/downstream of the image recording section 42). The printing means 62 is not limited to any form, and it is possible to utilize various kinds of known printing means such as an impact printer using an ink ribbon or an ink jet printer. Note that the printing means 62 is disposed in a number equivalent to the number of maximum images that can be imposed in the width direction (x direction: that is, a direction orthogonal to the conveying direction) of the recording medium.

In addition, the content to be recorded as the back print is not particularly limited, and it is possible to arbitrarily set the content. For example, the content may conform to the standard of the back print set in the photographic printer.

The image recording section 42 is a section for recording an image onto the recording medium A by electrophotography. The image recording section 42 includes an exposure subsection 68, a toner image forming subsection 70, a transferring subsection 72, and a primary fixing roller pair 74.

The exposure subsection 68 is a known light beam scanning optical system having a light source of light beam (recording light) for exposing an electrophotographic photosensitive drum 80 which is to be described later, a light deflection device, an fθ lens, a light path changing mirror, a light beam adjusting lens, and the like.

That is, the exposure subsection 68 records a latent image onto the electrophotographic photosensitive drum 80 by deflecting the light beam modulated in accordance with the image data (namely, the image to be recorded) supplied from the data processing section 34 in the main scanning direction matching the x direction (the width direction of the recording medium A: that is, the direction orthogonal to the conveying direction (the y direction) of the recording medium A), and by bringing the deflected light beam to be incident at a predetermined exposure position. As described above, because the printer 10 shown in FIG. 1 carries out the image imposition in accordance with a print size and the recording medium A to be used to carry out image recording. In a case of the multi-image imposition, the exposure subsection 68 emits light beam modulated in accordance with the image imposition and each of the images to form a plurality of latent images in accordance with the image imposition onto the electrophotographic photosensitive drum 80.

The toner image forming subsection 70 is a known subsection for forming a toner image by electrophotography. The toner image forming subsection 70 includes the electrophotographic photosensitive drum 80 (hereinafter referred to as the photosensitive drum 80), charging means 82, cleaning means 84, and toner supply means 86.

The photosensitive drum 80 is a known electrophotographic photosensitive drum, and is rotated in a direction of an arrow a shown in FIG. 1 (a direction opposite to the y direction), with its central axis matching the x direction. As described above, because the light beam emitted from the exposure subsection 68 is deflected in the x direction, the photosensitive drum 80 is two-dimensionally scanned and exposed by the light beam modulated in accordance with the image to be recorded. In addition, with regard to the toner supply means 86, four toner image supply parts, namely, a cyan (C) toner image supply part 86C, a magenta (M) toner image supply part 86M, an yellow (Y) toner image supply part 86Y, and a black (K) toner image supply part 86K are disposed on a rotatable drum-like member 86a at intervals of a rotational angle of 90°.

The transferring subsection 72 is configured by a transfer belt 88 that is an endless belt a part of which contacts the photosensitive drum 80, three rollers 90 around which the transfer belt 88 is stretched, a pressure roller 92 for pressing the transfer belt 88 against the photosensitive drum 80 from the inside, and a transfer roller 94. The transfer belt 88 is rotated in a direction of an arrow b shown in FIG. 1 (same direction as the y direction) and acts as an intermediate transfer member of a toner image. In addition, the transfer roller 94 is capable of moving to a position at which the transfer roller 94 nips the transfer belt 88 together with one of the rollers 90 and to a position at which the transfer roller 94 is separated from the transfer belt 88.

While being rotated in the direction of the arrow a shown in FIG. 1, the photosensitive drum 80 is uniformly charged to the x direction by the charging means 82, and is two-dimensionally scanned and exposed by the light beam modulated in accordance with the image data. Thereby, an electrostatic latent image is formed on the surface of the photosensitive drum 80 due to loss of charge at the portion exposed to the light beam. Then, the electrostatic latent image is developed by the toner supply part positioned at a developing position (a position facing the photosensitive drum 80) of the toner supply means 86, for example, by the Y toner image supply part 86Y, and the toner image of Y is formed on the surface of the photosensitive drum 80.

In addition, the transfer belt 88, a part of which is pressed by the pressure roller 92 to be brought into contact with the photosensitive drum 80, is rotated in the direction of the arrow b shown in FIG. 1 in synchronization with the rotation of the photosensitive drum 80. Therefore, the toner image of the photosensitive drum 80 that is developed by the toner supply means 86 is transferred onto the transfer belt 88 at the pressed part. The region of the photosensitive drum 80 whose toner image is completely transferred onto the transfer belt 88 is removed of the remaining toner by the cleaning means 84.

In the embodiment illustrated in FIG. 1, such forming of the toner image and the transfer of the toner image onto the transfer belt 88 are carried out by a sequential action by the four toner supply parts of the C toner image supply part 86C, the M toner image supply part 86M, the Y toner image supply part 86Y, and the K toner image supply part 86K.

In this regard, for example, after the Y toner image is transferred onto the transfer belt 88, the toner supply means 86 (the member 86a) is rotated in a direction of an arrow c shown in FIG. 1 by 90°, makes the M toner image supply part 86M be positioned at the developing position, and then forming of a latent image is started after aligning the position with the position of the Y toner image on the transfer belt 88. An M toner image is formed on the surface of the photosensitive drum 80 in the same manner, and then is transferred onto the transfer belt 88. Thereafter, in the same way, a C toner image is transferred onto the transfer belt, and a K toner image is transferred onto the transfer belt. Note that the transfer roller 94 is separated from the transfer belt 88 during the above operation.

Therefore, in the embodiment illustrated in FIG. 1, each toner image of Y, M, C, and K is formed on the surface of the transfer belt 88 with the positions being aligned: that is, the (full) color image of four colors is formed. In addition, the printer in the embodiment illustrated in FIG. 1 carries out the image imposition in accordance with a print size and the recording medium A to be used to perform image recording, so that in a case of carrying out the multi-image imposition, a plurality of images arranged at predetermined positions are formed on the transfer belt 88.

On the other hand, a cut sheet-like recording medium A of a predetermined size is supplied from the supply section 40, and the supplied recording medium A is in a standby state at a predetermined position, for example, at a position of the conveying roller pair 60 immediately upstream of the transfer roller 94.

After the color image is formed on the transfer belt 88, the conveyance of recording medium A is started at a timing in accordance with the rotation of the transfer belt 88 so that the position of the recording medium A and the position of the color image formed on the transfer belt 88 are matched with each other. In addition, the transfer roller 94 is pressed against the transfer belt 88 (the rollers 90), so that the recording medium A is conveyed while being nipped between the transfer belt 88 and the transfer roller 94.

By conveying the recording medium A while being nipped between the transfer belt 88 and the transfer roller 94 as above, the toner image of four colors formed on the surface of the transfer belt 88 is transferred to the recording medium A, and the image (the imposed image) is formed on the surface of the recording medium A.

Note that in the printer 10 shown in FIG. 1, the position of each image on the recording medium A is determined with the front end of the recording medium A in the y direction (an end Ex1 to be described later) and an end in the x direction on the side on which the image with a greater frame number is positioned (an end Ey1 to be described later) as a standard.

The recording medium A on which the image is formed is conveyed to the primary fixing roller pair 74 by a belt conveyor 96.

The primary fixing roller pair 74 is a conveying roller pair, one of which is a heating roller. The recording medium A is heated and pressed while being nipped and conveyed by the primary fixing roller pair 74, and then the toner-image is fixed onto recording medium A. In a case of the four-image imposition as described above, the images 1 through 4 are formed on the recording medium A as shown in FIG. 2.

Note that the images are recorded so as to be arranged in frame order in the y direction as described above. In addition, in the embodiment shown in FIG. 2, the images (the latent images of respective images on the photosensitive drum 80) are recorded with being separated from one another. However, in the present invention, the images may be recorded while being brought into contact with one another, or the images may be recorded with the ends of the respective images overlapping one another.

The recording medium A onto which the toner image is fixed by the image recording section 42, is then conveyed to the secondary fixing section 44.

The secondary fixing section 44 is configured by a heating roller 100, a roller 102, a secondary fixing belt 104 that is an endless belt stretched around the heating roller 100 and the roller 102, cooling means 106 that is provided to the inside of the secondary fixing belt 104 to contact therewith, and a nip roller 108 that nips the secondary fixing belt 104 together with the heating roller 100.

The recording medium A is nipped and conveyed by the secondary fixing belt 104 (the heating roller 100) and the nip roller 108, so that the recording medium A is heated and thus the toner is melted. Then, the recording medium A is cooled by the cooling means 106 and the melted toner image is cured. In the printer 10 shown in FIG. 1, by adjusting the conditions for the heating and the cooling, glossiness is applied to the surface of the recording medium A (print), and in addition, it is possible to adjust the level of the glossiness. For example, it is possible to form a print (hard copy) having a quality equal to the quality of a photographic print for which a photograph paper is used.

Note that in the printer 10 of the present invention, the method for recording an image is not limited to a method for the electrophotography as shown in FIG. 1, and any known image recording method can be utilized.

For example, the image recording methods as implemented by various kinds of known printer (printing means) such as a digital photo printer in which a photosensitive material (photographic paper) is exposed in accordance with light beam (recording light) modulated based on image data obtained by photoelectrically reading a film or image data of an image photographed by a digital camera to record a latent image and the exposed photosensitive material is subjected to a predetermined wet treatment, an analogue photo printer that exposes a photosensitive material by projected light of the film to carry out a predetermined wet treatment to the exposed photosensitive material, a printer having a heat-developing process in which a photosensitive heat-developing photosensitive material for transferring and forming an image onto an image receiving medium under existence of an image forming solvent such as water and the like, an ink jet printer, and a thermal printer using a thermal head can be utilized.

The recording medium A that has undergone the secondary fixing of the image, namely, the recording medium A on which the plural images are formed by the image forming unit 14, is conveyed to the cutting unit 16. Then, the cutting unit 16 cuts the images into prints each having a predetermined size based on the cutting control by the controlling section 18 in accordance with the image imposition information transferred from the data processing section 34.

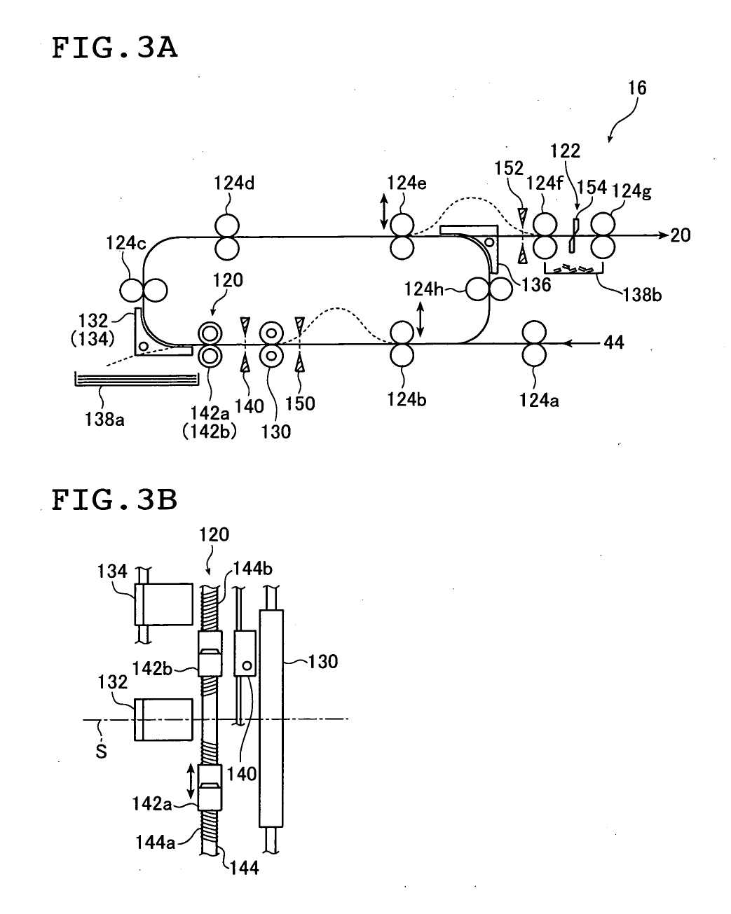

FIG. 3A shows a conceptual diagram of the cutting unit 16.

The cutting unit 16 is a unit for cutting the recording medium A in the y direction (the conveying direction of the recording medium A) and in the x direction (the width direction of the recording medium A: that is, the main scanning direction) to make the recording medium A cut into prints each having a predetermined size corresponding to an image. As one example, in a case of performing the four-image imposition as shown in FIG. 2 as described above, the cutting unit 16 cuts the recording medium A at four positions of cutting lines Cy1, Cy2, Cy3, and Cy4 in the y direction and cuts the recording medium A at four positions of cutting lines Cx1, Cx2, Cx3, and Cx4 in the x direction, to produce four prints of a predetermined size.

As shown in FIG. 3, the cutting unit 16 includes a first cutting section 120, a second cutting section 122, conveying roller pairs 124 (124a to 124h), a registration roller pair 130, a first guide 132, a second guide 134 (see FIG. 3B), a third guide 136, disposal trays 138a and 138b, and an end sensor 140. In addition, a sensor 150 is disposed upstream of the registration roller pair 130, and a sensor 152 is disposed upstream of a conveying roller pair 124f.

Note that in the printer 10, it is needless to say that the cutting unit 16 may include various kinds of known members provided to the device for carrying out various kinds of processing by conveying a sheet-like material such as conveying means for conveying the recording medium A such as the conveying roller pair, a conveying guide, moving means of the conveying guide, various kinds of sensors for detecting a recording medium, various kinds of members and the like, as well as various kinds of members shown in FIG. 1.

As described above, the recording medium A that has been subjected to the fixing processing by heating and cooling by the secondary fixing section 44 is conveyed by the conveying roller pairs 60 and the like to be supplied to the cutting unit 16, and is then conveyed by the conveying roller pairs 124.

Each of the conveying roller pairs 124 is basically an ordinary conveying roller pair used for conveying a sheet-like material. Note that each of the conveying roller pairs 124b and 124e is brought into a nipped (held) state and a nip released state by vertically moving an upper side roller. In addition, the conveying roller pair 124f acts as front end alignment means with respect to a second cutting section 122. With respect to this point, the explanation is to be made later.

In the cutting unit 16, first, the conveying roller pairs 124a and 124b convey the recording medium A to a registration roller pair 130. A sensor 150 for detecting the front end (the end Ex1) of the recording medium A is disposed upstream of the registration roller pair 130. Note that no special limitation is made as to the form of the sensor 150 (and a sensor 152 to be described later), and it is possible to utilize various kinds of known means for detecting a sheet-like material such as an optical sensor and a mechanical sensor.

FIG. 3B is a schematic top view showing the registration roller pair 130 through the first guide 132, and the second guide 134.

The registration roller pair 130 is conveying means for conveying the recording medium A, and also serves both as the front end alignment means for aligning the front end of the recording medium A and the position adjustment means for adjusting the position of the recording medium A. That is, the registration roller pair 130 abuts on the front end (in the y direction) of the recording medium A to align (adjust) the front end side (the end Ex1 in FIG. 2) in the x direction, and regulates the position of the front end, and in addition, moves in the x direction in a state in which the recording medium A whose front end is aligned in the x direction is nipped between the rollers of the registration roller pair 130 to match an image center with a cutting center to be described later.

There is no special limitation as to the method for moving the registration roller pair 130 in the x direction. That is, it is possible to utilize various kinds of known method for moving the rotating roller in the direction of the rotational axis such as a method utilizing a ball spline mechanism.

The end sensor 140 is disposed downstream of the registration roller pair 130. In the cutting unit 16, the end sensor 140 is moved to the x direction to detect the end of the recording medium A in the x direction. In the embodiment shown in FIG. 2, the end sensor 140 detects the end Ey1 (the end on the side on which an image with greater number is positioned). In the cutting unit 16, the position of each print (image) in the x direction is detected by detecting the end Ey.

There is no special limitation as to the form of the end sensor 140, and it is possible to utilize various kinds of known method for detecting the sheet-like material such as an optical sensor, mechanical sensor, and an electric sensor.

The first cutting section 120 is disposed downstream of the end sensor 140.

The first cutting section 120 is a section for cutting the recording medium A along the y direction (cutting along the cutting line Cy) to make each image have a print size (predetermined width) in the x direction. In the embodiment shown in FIG. 3B, the first cutting section 120 includes a first cutter 142a and a second cutter 142b for cutting the recording medium A in the y direction, and a retaining shaft 144 which extends in the x direction and retains the both cutters.

The first cutter 142a and the second cutter 142b are so-called known slitter, which has an upper blade and a lower blade and cuts a sheet-like material to be conveyed in the conveying direction.

Onto the retaining shaft 144, screws (a right screw and a left screw) that rotate in opposite directions with each other are formed to be symmetrical with respect to a reference position S in the x direction indicated by a dashed line in FIG. 3B. The first cutter 142a is screwed onto one screw 144a, and the second cutter 142b is screwed onto the other screw 144b, whereby the retaining shaft 144 retains the cutters. In addition, both the first cutter 142a and the second cutter 142b are positioned separately from the reference position S by the same distance in the x direction. Further, a rotational driving source (not shown) is engaged with the retaining shaft 144 for rotating it.

Therefore, the reference position S becomes a central position (cutting center) in the x direction between a cutting position at which the recording medium A is cut in the y direction by the first cutter 142a and a cutting position at which the recording medium A is cut in the y direction by the second cutter 142b. Further, by rotating the retaining shaft 144 by the rotational driving source, the first cutter 142a and the second cutter 142b approach or separate from the reference position S by the same distance, so that a cutting width in the x direction can be adjusted with the cutting center matching the reference position S.

The first guide 132 and the second guide 134 are disposed downstream of the first cutting section 120. In addition, the disposal tray 138a is disposed in a lower position in the downstream of the first cutting section 120.

In the recording medium A which was cut by the first cutting section 120, a recording medium which was cut off to have a print size in the x direction (that is, a recording medium with no margin in the x direction) (hereinafter referred to as the cut (recording) medium) is guided to the conveying roller pair 124c by the first guide 132. The conveying roller pair 124c is disposed downstream of the first guide 132. The first guide 132 is disposed with the center position thereof in the x direction matching the reference position S.

On the other hand, in the recording medium A which was cut by the first cutting section 120, a recording medium which was cut off with the width not equal to a print size in the x direction (that is, a recording medium with a greater margin in the x direction) and on which an image is recorded (hereinafter referred to as the uncut (recording) medium) is guided to the conveying roller pair 124c by the second guide 134. The conveying roller pair 124c is disposed downstream of the second guide 134.

As shown in FIG. 3A and FIG. 3B, the first guide 132 and the second guide 134 are disposed side by side in the x direction and at the same position in the y direction (conveying direction). In addition, the second guide 134 is movable in the x direction by known means.

The disposal tray 138a is a tray for accommodating parts of the recording medium A that are cut off by the first cutting section 120 and are not guided by the first guide 132 or the second guide 134, that is, parts that do not become a final print (in other word, shreds of the recording medium A including margins).

In the downstream of the first guide 132 and the second guide 134, there are disposed the conveying roller pairs 124c to 124e, and the third guide 136 is disposed downstream thereof.

The third guide 136 is positioned on the conveying path of the uncut medium and guides the uncut medium to a predetermined path extending toward the registration roller pair 130. Therefore, the cut medium and the uncut medium are separated from each other at this point.

The cut medium passes through the third guide 136 and is conveyed by the conveying roller pair 124f to the second cutting section 122.

Note that the conveying roller pair 124f is, like the registration roller pair 130 as described above, serves also as the front end alignment means for the recording medium A. The conveying roller pair 124f makes the front end of the cut medium abut thereon to align the front end side of the cut medium in the x direction, and regulates the position of the front end (in the y direction).

The second cutting section 122 is a cutting section for cutting the cut medium in the x direction (cut along the cutting line Cx) by a so called guillotine cutter 154 to make each print (image) have a predetermined print size in the y direction, whereby each print can have a desired predetermined print size both in x direction and the y direction.

The conveyance of the cut medium by the conveying roller pair 124f is stopped at the time the cutting position of the cut medium in the y direction (cutting line Cx) comes to the cutting position by the guillotine cutter 154 of the second cutting section 122. Then, each print is cut into a predetermined print size by repeating the process of actuating the guillotine cutter 154, cutting the cut medium in the x direction, and resuming the conveyance of the recording medium by the conveying roller pair 124f, until there is no cutting position on the cut medium.

The prints cut into the predetermined size by the second cutting section 122 are discharged from the cutting unit 16 by the conveying roller pair 124g, are then supplied to the sorter 20 by the conveying roller pairs 60, and then are accumulated per one print job.

In addition, parts other than the prints of the cut medium that are cut by the second cutting section 122 (that is, shreds including margins) fall to be accommodated onto the disposal tray 138b.

On the other hand, the uncut medium guided to the third guide 136 is conveyed by the conveying roller pair 124h to be supplied again to the conveying roller pair 124b, and then conveyed by the conveying roller pair 124b so as to be supplied to the first cutting section 120 from the registration roller pair 130.

That is, in the cutting unit 16, a loop-like conveying path is formed. The loop-like conveying path extends from the registration roller pair 130 to the first cutting section 120, then to the third guide 136, and then to the registration roller pair 130. The uncut medium is supplied again to the first cutting section 120 by the loop-like conveying path, and is cut in the y direction so as to be the cut medium which has a print size in the x direction (that is, the cut medium with no margin in the x direction).

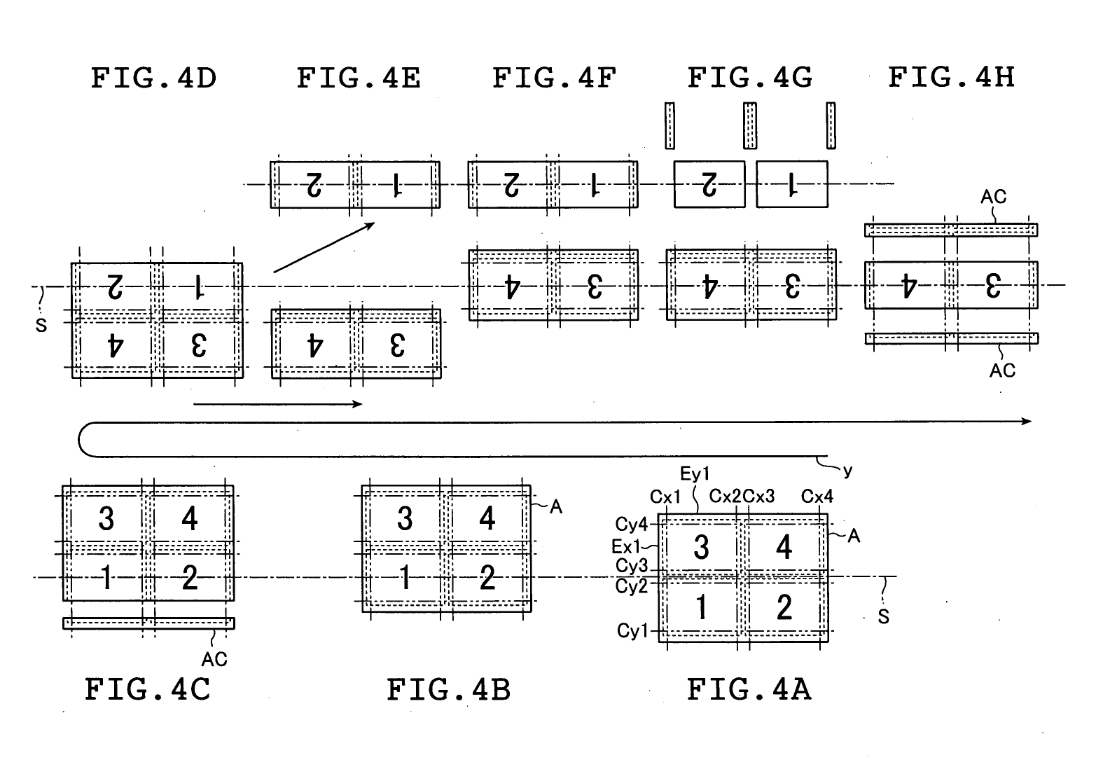

Hereinafter, an explanation is made in more detail as to the cutting unit 16 and the present invention with reference to the conceptual diagram of FIGS. 4A to 4H by explaining the cutting control by the controlling section 18 and the action of the cutting unit 16 controlled by the controlling section 18 in a case of the four-image imposition with two images in the x direction and two images in the y direction as shown in FIG. 2.

As described above, in the printer 10, the images are formed on the recording medium A so that the images are arranged in a predetermined order (frame number order) in the y direction. Therefore, in the case of the four-image imposition as shown in FIG. 2, the images are formed as follows. The image 1 and the image 2 are arranged in the y direction and the image 3 and the image 4 are arranged in the y direction, and these image columns in the y direction are arranged in the x direction.

The recording medium A on which the images are formed in this way is subjected to the secondary fixing by the secondary fixing section 44, and is then conveyed to the cutting unit 16 by the conveying roller pairs 60.

In the cutting unit 16, the recording medium A is conveyed to the registration roller pair 130 by the conveying roller pairs 124a and 124b. Note that in the embodiment illustrated in FIG. 4A, at the time the recording medium A is conveyed into the cutting unit 16, the center position of the recording medium A in the x direction (width direction) is matched with the reference position S (the dashed line). However, the present invention is not limited to this.

At first, the registration roller pair 130 is stopped in a nipped (held) state. When the conveying roller pairs 124a and 124b convey the recording medium A, first, the sensor 150 detects the front end Ex1, and further, the end Ex1 is abutted on the registration roller pair 130 (between the rollers of the registration roller pair 130).

The conveyance of the recording medium A by the conveying roller pairs 124a and 124b is stopped at the time the recording medium A is conveyed by a predetermined length after the end Ex1 is abutted on the registration roller pair 130, in accordance with the result of detection of the end Ex1 by the sensor 150. Therefore, as shown by the dotted line in FIG. 3A, the recording medium A forms a loop, so the direction of the end Ex1 and the x direction (the main scanning direction: that is, the width direction) are completely matched with each other. In addition, the front end position of the recording medium A (the position of the end Ex1) is determined. Thus, the front end alignment of the recording medium A is ended.

In addition, when the distance between the first cutter 142a and the second cutter 142b is not equal to the print size in the x direction, the retaining shaft 144 is rotated to make the first cutter 142a and the second cutter 142b approach or be separated from the reference position S, thereby setting the distance between the first cutter 142a and the second cutter 142b to be the print size in the x direction.

Then, when the registration roller pair 130 slightly conveys the recording medium A, the conveying roller pair 124b releases the nip of the recording medium A. The registration roller pair 130 further conveys the recording medium A by a predetermined length corresponding to the position of the end sensor 140, and then the registration roller pair 130 is stopped.

Next, the end sensor 140 is moved in the x direction and detects the end Ey1 that is the reference for the image forming position in the x direction.

At this time, the position of the recording medium A whose front end is aligned by abutting the front end thereof on the registration roller pair 130 and by forming a loop may be moved in the x direction.

Here, as described above, in the printer 10, the position of each image is determined with the front end (the end Ex1) of the recording medium A and the end in the x direction on the side on which the image with a greater frame number is positioned (namely, the end Ey1) as the reference. That is, in the printer 10, the distance from the end Ey1 to the end of each image in the x direction is of course already known.

Therefore, it is possible to appropriately detect the image position in the x direction by detecting the end Ey1 by the end sensor 140 on a downstream side of the registration roller pair 130 that carries out the front end alignment of the recording medium A.

When the end Ey1 of the recording medium A is detected, the center position of the image 1 (and the image 2) in the x direction is detected by using the result of detection of the end Ey1, then the registration roller pair 130 is moved in the x direction, and the image center of the image 1 (and the image 2) and the reference position S are matched with each other as shown in FIG. 4B.

When the image center of the image 1 and the reference position S are matched with each other, the conveyance of the recording medium A by the registration roller pair 130 is resumed. The recording medium A is conveyed to the first cutting section 120, so that the recording medium A is cut in the y direction by the first cutter 142a and the second cutter 142b.

As described above, the distance between the first cutter 142a and the second cutter 142b is equal to the print size in the x direction. In addition, the cutting center (the center between the cutting positions for the first cutter 142a and the second cutter 142b) is matched with the reference position S.

Therefore, the first cutter 142a is positioned to match the cutting line Cy1, and the second cutter 142b is positioned to match the cutting line Cy2, respectively. Thus, in the first cutting section 120, the recording medium A is cut along the both cutting lines to produce the cut medium on which the image 1 and the image 2 are recorded and whose side in the x direction is the print size (that is, the cut medium with no margin in the x direction), and the uncut medium on which the image 3 and the image 4 are recorded (that is, the uncut medium with a margin in the x direction).

The cut medium and the uncut medium cut off by the first cutting section 120 are further conveyed by the registration roller pair 130.

In this case (when there is the uncut medium), the second guide 134 is positioned (in the x direction) in the conveying path of the uncut medium (including the image 3 and the image 4 thereon). Therefore, the cut medium (including the image 1 and the image 2 thereon) and the uncut medium (including the image 3 and the image 4 thereon) are guided by the first guide 132 and the second guide 134, respectively, and are supplied to the conveying roller pair 124c that is located downstream thereof.

On the other hand, the recording medium including a margin which was cut by the first cutter 142a and whose ends correspond to the cutting line Cy 1 and the end Ey1, namely, a shred including a margin which is indicated by reference symbol AC in FIG. 4C, is not guided by any member, but falls to be accommodated onto the disposal tray 138a.

The cut medium and the uncut medium are further conveyed downstream by the conveying roller pairs 124d and 124e as shown in FIG. 4D.

Here, in the downstream of the conveying roller pair 124e, the third guide 136 is positioned in the conveying path of the uncut medium. Therefore, as shown in FIG. 4E, the cut medium and the uncut medium are separated in this position. The cut medium is not guided by the third guide 136 but conveyed to the conveying roller pair 124f on the side of the second cutting section 122, and the uncut medium is guided by the third guide 136 to be conveyed to the conveying roller pair 124h which configures a loop-like conveying path oriented toward the registration roller pair 130.

The conveying roller pair 124f, which conveys the cut medium, also serves as the front end alignment means. The conveying roller pair 124f is stopped in the nipped state in the same manner as the above registration roller pair 130.

When the conveying roller pair 124e conveys the cut medium, first, the sensor 152 detects the end Ex1, and further, the end Ex1 is abutted on the conveying roller pair 124f. In the same manner as the front end alignment by the registration roller pair 130 described above, when the cut medium is conveyed by a predetermined length after the end Ex1 is abutted on the conveying roller pair 124f, the conveyance of the cut medium is stopped, in accordance with the result of detection of the end Ex1 by the sensor 152. Thereby, the cut medium forms a loop as shown in FIG. 3A, so that the direction of the end Ex1 completely matches the x direction and the front end position of the cut medium is determined. Thus, the front end alignment of the cut medium is ended.

When the front end alignment of the cut medium is ended, the conveying roller pair 124f starts to convey the cut medium. In the same manner as the above-mentioned case, when the cut medium is conveyed by the conveying roller pair 124f by a predetermined length, the conveying roller pair 124e releases the holding of the cut medium, and the cut medium is conveyed to the second cutting section 122.

The conveyance of the cut medium by the conveying roller pair 124f is stopped when the cutting position of the cut medium in the y direction (the cutting line Cx1) comes to the cutting position by the guillotine cutter 154 of the second cutting section 122. As described above, the position for recording each image onto the recording medium A is determined with the end Ex1 and the end Ey1 as the reference. That is, in the printer 10, the distance from the front end Ex1 to the end of each image in the y direction is already known. Therefore, by regulating the front end position of the cut medium by the conveying roller pair 124f, the cutting position of each print in the y direction can be determined based on the conveyance amount therefrom.

In the second cutting section 122, when the guillotine cutter 154 cuts the cut medium along the cutting line Cx1, the conveyance by the conveying roller pair 124f is resumed. Then, the conveyance is stopped when the cutting line Cx2 comes to the cutting position by the guillotine cutter 154. Then, the cut medium is cut by the guillotine cutter 154 to produce a print of a predetermined size on which the image 1 is recorded. After the cutting, the conveyance is resumed. Thereafter, in the same way, the cut medium is sequentially cut along the cutting line Cx3 and the cutting line Cx4, to produce a print of a predetermined size on which the image 2 is recorded (see FIG. 4G).

Note that parts of the cut medium other than the prints (images) that are cut off by the second cutting section 122 and include margins fall to be accommodated onto the disposal tray 138b.

The prints cut off by the second cutting section 122 are conveyed by the conveying roller pair 124g. Then, the prints are discharged from the cutting unit 16, and further conveyed to the sorter 20 by the conveying roller pairs 60 to be accumulated.

On the other hand, the uncut medium (including the image 3 and the image 4 thereon) guided by the third guide 136 is conveyed to the conveying roller pair 124b from the conveying roller pair 124h. Thereafter, basically, the uncut medium is cut in the same manner as the recording medium A and the cut medium (including the image 1 and the image 2) described above.

That is, the conveying roller pair 124b conveys the uncut medium to make the end Ex1 (front end) abut on the registration roller pair 130 as in the case of the recording medium A, thereby aligning the front end of the uncut medium.

When the front end alignment of the uncut medium is ended, the registration roller pair 130 starts to convey the uncut medium. When the uncut medium is conveyed by a predetermined length, the conveying roller pair 124 releases the nip of the uncut medium. Then, when the uncut medium is further conveyed by a predetermined length, the conveyance is stopped. Then, the end sensor 140 is moved in the x direction to detect the end Ey1 of the uncut medium.

Next, in accordance with the result of the detection, the registration roller pair 130 is moved in the x direction, and the image center of the image 3 (and the image 4) and the reference position S are matched with each other as shown in FIG. 4F.

When the image center of the image 3 and the reference position S are matched with each other, the conveyance of the uncut medium by the registration roller pair 130 is resumed to convey the uncut medium to the first cutting section 120, thereby cutting the uncut medium by the first cutter 142a and the second cutter 142b.

As described above, the cutting center (between the first cutter 142a and the second cutter 142b) matches the reference position S, and therefore, by matching the image center of the image 3 with the reference position S, the position of the first cutter 142a matches the cutting line Cy3, and the position of the second cutter 142b matches the cutting line Cy4, respectively.

Therefore, the uncut medium is cut along the both cutting lines Cy to produce a cut medium on which the image 3 and the image 4 are recorded and whose side in the x direction is the print size (that is, a cut medium with no margin in the x direction).

The cut medium (including the image 3 and the image 4) cut off by the first cutting section 120 is further conveyed by the registration roller pair 130.

At this time (when there is no uncut medium left), the second guide 134 is retreated from the conveying path of the recording medium. Therefore, the cut medium (including the image 3 and the image 4) only is guided by the first guide 132 positioned at the reference position S. In addition, a recording medium including a margin which is cut off by the first cutter 142a so that the ends thereof correspond to the cutting line Cy2 and the cutting line Cy3 (a shred AC including a margin in FIG. 4H), and a recording medium including a margin which is cut off by the second cutter 142b so that the ends thereof correspond to the cutting line Cy4 and the end Ey1 (a shred AC including a margin in FIG. 4H) are not guided by any member, but fall to be accommodated onto the disposal tray 138a.

In the same manner as described above, the cut medium on which the image 3 and the image 4 are recorded are conveyed to the downstream side by the conveying roller pairs 124d and 124e, then passes through the third guide 136 positioned in the conveying path of the uncut medium, and then is conveyed to the conveying roller pair 124f on the side of the second cutting section 122.

When the conveying roller pair 124e conveys the cut medium, the sensor 152 detects the end Ex1 (front end) as described above, and further the front end of the cut medium is aligned by abutting the end Ex1 on the conveying roller pair 124f. Then, the conveying roller pair 124f starts to convey the cut medium. When the cut medium is conveyed by the conveying roller pair 124f by a predetermined length in the same manner described above, the conveying roller pair 124e releases the holding of the cut medium, and the cut medium is conveyed to the second cutting section 122.

In the second cutting section 122, in the same manner as described above, when the cutting position of the cut medium comes to the cutting position by the guillotine cutter 154, the conveyance by the conveying roller pair 124f is stopped. Then, the cut medium is cut by the guillotine cutter 154, and the conveyance by the conveying roller pair 124f is resumed. This is sequentially carried out along the cutting line Cx1 and the cutting line Cx2 of the image 3, and the cutting line Cx3 and the cutting line Cx4 of the image 4, to produce a print of a predetermined size on which the image 3 is recorded and a print of a predetermined size on which the image 4 is recorded.

The cut prints are discharged from the cutting unit 16 by the conveying roller pair 124g to the sorter 20 by the conveying roller pairs 60 to be accumulated. In addition, parts of the cut medium other than the cut prints (images), that is, shreds including margins, fall to be accommodated onto the disposal tray 138b.

The above embodiment is of the case where the images are recorded in the four-image imposition to produce the prints of the same size in the center of the recording medium A. However, the present invention is not limited to this. That is, various kinds of forms of the multi-image impositions can be utilized.

For example, depending on the size of the recording medium A, the print size, and the number of images for imposition, in some cases, a great margin is left which is larger than other margins of the recording medium A as shown in FIG. 5A. However, the present invention, in which the recording medium A is cut in the y direction while the image center and the cutting center are matched with each other to make the recording medium A in the x direction be a print size, can be suitably adapted to the above case without specially changing the process or the like.

The number of images in the x direction formed on the recording medium A is not limited to two as shown in the embodiment in FIG. 2. That is, the present invention can be adapted to the imposition of various numbers of images in accordance with the size of the recording medium A and a print size.

For example, in a case where six-image imposition with three images in the x direction is carried out, as shown in FIG. 5B, three images are formed in the x direction so that the images are formed in the order of the images in the y direction. In this case, first, in the first cutting section 120, a cut medium on which the image 1 and the image 2 are recorded is produced, which is fed to the second cutting section 122 to make each image be cut into a print size, and an uncut medium on which the image 3 through the image 6 are recorded is again supplied to the first cutting section 120. Then, a cut medium on which the image 3 and the image 4 are recorded is produced, which is fed to the second cutting section 122 to make each image be cut into a print size. Finally, in the same way, a cut medium on which the image 5 and the image 6 are recorded is produced, and is cut to make each image have a print size.

In addition, in the present invention, the recording medium A is cut in the y direction into a print size in the x direction, and thereafter, the recording medium A is cut in the x direction to produce individual prints. Further, in a case where a plurality of images is formed in the x direction, the recording medium A is cut in the y direction in the order of the images.

Because of this, provided that all prints in each column in the y direction are of the same size in the x direction, there is no limitation with respect to the size (the size in the x direction and in the y direction) of the print formed on one recording medium A.

For example, as shown in FIG. 5C, the print size in the y direction may be different between the columns of prints in the y direction. In addition, the print size of each of the prints in the y direction may be different among the prints in each column in the y direction. In the case of the example shown in FIG. 5C, first, the first cutting section 120 produces a cut medium on which the image 1 and the image 2 are recorded, and the second cutting section 122 sequentially cuts the cut medium along the cutting lines Cx1, Cx2, Cx4, and Cx7 to produce two prints of a predetermined size. On the other hand, an uncut medium on which the image 3 through the image 5 are recorded is supplied to the first cutting section 120 again to be cut into a cut medium. Then, the second cutting section 122 cuts the cut medium sequentially along the cutting lines Cx1, Cx2, Cx3, Cx5, Cx6, and Cx8, to produce three prints of a predetermined size.

Further, provided that prints in each column in the y direction are of the same size in the x direction as shown in FIG. 5D, the print size in the x direction may be different from each other among the columns in the y direction. In this case, first, the distance between the first cutter 142a and the second cutter 142b is adjusted in accordance with the size of the image 1 and the image 2 in the x direction. Then, the first cutting section 120 cuts the recording medium A to produce a cut medium on which the image 1 and the image 2 are recorded. Then, the distance between the first cutter 142a and the second cutter 142b of the first cutting section 120 is changed in accordance with the size of the image 3 and image 4 in the x direction before an uncut medium on which the image 3 and the image 4 are recorded is again supplied to the first cutting section 120, thereby making it possible to implement the above configuration.

In addition, prints formed (the image formed) on one recording medium A are not limited to prints for one single job (one order: usually obtained by one roll of film or by a group of images). That is, prints for a plurality of jobs may be recorded onto one recording medium.

In this case, as shown in FIG. 5E, a mark M (sort mark (order mark)) indicating a boundary between jobs is recorded between the last image of one job (an image 24 in the example shown in FIG. 5E) and the first image of the next job (the image 1 in the example shown in FIG. 5E). In addition, a sensor for reading the mark is provided to the second cutting section 122 on an upstream of the guillotine cutter 154 (cutting means), and the sorter 20 accumulates the prints per job. Thereby, it is possible to use the recording medium A without any wastage.

Further, in the present invention, the number of the recording medium A existing in the cutting unit 16 is not limited to one. That is, it is possible to suppress the waste of time taken for the cutting operation and to improve an efficiency of production of prints by supplying a plurality of the recording media A.

As one example, as shown in FIG. 5F, the images 1, 2, 5 and 6 are recorded onto a first recording medium A1, and the images 3, 4, 7 and 8 are recorded onto a second recording medium A2.

In the cutting unit 16, after cutting off a cut medium on which the image 1 and the image 2 are recorded from the recording medium A1 by the first cutting section 120, the recording medium A2 is supplied to the first cutting section 120, and then a cut medium on which the image 3 and the image 4 are recorded is cut off from the recording medium A2 by the first cutting section 120. The cut medium on which the image 1 and the image 2 are recorded is supplied to the second cutting section 122 to be cut into a print size. An uncut medium on which the image 5 and the image 6 are recorded is returned to the first cutting section 120 via the above described loop, and then cut to be a cut medium.

Meanwhile, the cut medium on which the image 3 and the image 4 are recorded is supplied to the second cutting section 122 to be cut into a print size. An uncut medium on which the image 7 and the image 8 are recorded is returned to the first cutting section 120 via the above described loop, and then cut to be a cut medium.

Next, the cut medium on which the image 5 and the image 6 are recorded is supplied to the second cutting section 122 to be cut into a print size. Finally, the cut medium on which the image 7 and the image 8 are recorded is supplied to the second cutting section 122, and cut into a predetermined print size.

As is clear from the above explanation, according to the present invention, the image center and the cutting center are matched with each other, and the recording medium A is cut in the y direction to make the side thereof in the x direction cut into a print size. Thereby, it is possible to cut the recording medium into a predetermined size in the x direction, in a manner suitably corresponding to individual prints, regardless of the size of the recording medium A or the form of imposition of each of the images. Specially, it is possible to always make the center position of the print in the x direction be the same position by fixing the cutting center for the cutter to cut the recording medium in the y direction and by matching the image center with the cutting center by moving the recording medium in the x direction, as shown in the examples in the drawings. Thus, it is possible to readily accumulate prints in one same place without carrying out any special processing.

In addition, according to the present invention, the loop-like conveying path is set, and the cutting operations are sequentially carried out by supplying the recording medium to the same first cutting section for the necessary number of times in accordance with the number of images in the x direction. Thereby, it is possible to cut the recording medium with two cutters regardless of the number of images in the x direction. Therefore, it is also possible to simplify the configuration of the apparatus and the control of the cutters. Further, provided that prints arranged in the y direction are of the same size in the x direction, it is possible to cut each print into a print size. Thus, the flexibility as to the size of the prints (images) subjected to the multi-image imposition is very high, so that the present invention can be suitably adapted to production of prints in which various sizes are present in a mixed manner.

Further, by forming the image on the recording medium so that images are formed in image order (frame number order) in the y direction, as well as matching the image center and the cutting center by moving the recording medium, it is possible to accumulate prints in a sequential order without carrying out any special processing.

In the embodiment shown in the drawing, the first cutting section 120 cuts the recording medium A in the y direction by the slitter and the second cutting section 122 cuts the recording medium A in the x direction by the guillotine cutter. However, the present invention is not limited to this configuration. That is, it is possible to utilize cutting means of various kinds for cutting the sheet-like materials for the cutter (cutting means).

For example, the cutting in the y direction may be carried out with the guillotine cutter. Further, in addition to this, it is possible to utilize any cutting means of various kinds for cutting the sheet-like materials for the cutter such as a circular cutter for cutting by moving a circular blade with respect to a fixed blade, a rotary cutter using a rotary blade, and the like, together with the cutting means in the y direction and the cutting means in the x direction.

As described above, the cutting apparatus, the cutting method, and the printer according to the present invention are explained in detail. However, while the present invention has been described with reference to exemplary embodiments, it is to be understood that the invention is not limited to the disclosed exemplary embodiments. It is needless to mention that various improvements and modifications may be made without departing from the gist of the present invention.

What is claimed is:

1. A cutting apparatus comprising:
conveying means for conveying a recording medium on which at least one image is recorded;
a cutting section having two cutting means, each cutting means for cutting said recording medium in a conveying direction by said conveying means into a predetermined size in a width direction orthogonal to the conveying direction, said two cutting means being capable of adjusting a distance between said two cutting means in the width direction; and
position adjusting means for matching a cutting center, which is a central position in the width direction of two cutting positions at which cutting is carried out by said two cutting means, and an image center, which is a central position in the width direction of at least one image recorded onto said recording medium.

2. The cutting apparatus according to claim 1, wherein
said two cutting means are always separated from each other by a same distance with respect to a predetermined reference position in the width direction, and wherein
said position adjusting means moves said conveying means in the width direction on an upstream side of said two cutting means and matches said cutting center and said image center with each other by matching said image center with said reference position.

3. The cutting apparatus according to claim 1, further comprising:
front end alignment means for adjusting an orientation of said recording medium in the width direction toward an upstream side of said two cutting means.

4. The cutting apparatus according to claim 3, wherein
said front end alignment means is a pair of conveying rollers, said pair of conveying rollers, serving also as said conveying means for conveying said recording medium, and wherein
said position adjusting means matches said cutting center and said image center by moving said pair of conveying rollers in the width direction.

5. The cutting apparatus according to claim 3, further comprising:
end detecting means for detecting an end of said recording medium in the width direction, said end detecting means being provided on a downstream side of said front end alignment means, wherein
said position adjusting means matches said cutting center and said image center in accordance with a detection result of by said end determining means.

6. The cutting apparatus according to claim 1, further comprising:
a second cutting section disposed on a downstream side of said cutting means, said second cutting section cutting said recording medium in the width direction to make a length of said recording medium in the conveying direction be a predetermined length; and
second conveying means for conveying said recording medium cut by said cutting section to said second cutting section.

7. The cutting apparatus according to claim 6, wherein
at least two image are recorded on said recording medium, said recording medium having a margin around each of said at least two image, wherein
said cutting section cuts said recording medium in the conveying direction to separate said recording medium into a cut recording medium having no margin in the width direction and said predetermined size in the width direction, and an uncut recording medium that is the reminder of said recording medium and onto which at least one image is recorded, said uncut recording medium having the margin around said at least one image in the width direction, wherein
said second conveying means conveys both said cut recording medium and said uncut recording medium, and wherein
said cutting apparatus further comprises separating means for changing a conveying path of said uncut recording medium to a direction different from said second cutting section, said separating means being provided midway of said conveying path by said second conveying means.

8. The cutting apparatus according to claim 7, further comprising:
supplying means for supplying said cutting section with said uncut recording medium which is separated by said separating means.

9. A cutting method of cutting a recording medium on which plural images are recorded into plural prints of a predetermined size, said recording medium having a margin around each of said plural images, comprising:
cutting said recording medium by a first cutting section in a conveying direction orthogonal to the width direction in which two or more images are arranged to separate said recording medium into a cut recording medium having no margin in the width direction and a predetermined size in a width direction, and an uncut recording medium that is the reminder of said recording medium and onto which at least one image is recorded, said uncut recording medium having the margin around said at least one image in the width direction;
conveying said cut recording medium to a second cutting section;
cutting said cut recording medium by said second cutting section in the width direction to produce said print of the predetermined size in both the conveying direction and the width direction, said print having no margin in the both directions; and
cutting said recording medium into plural prints of the predetermined size by repeating an operation until there is no uncut recording medium, said operation comprising:
supplying again said uncut recording medium to said first cutting section to cut off said cut recording medium by first second cutting section,
conveying said cut recording medium to said second cutting section, and
cutting said cut recording medium by said second cutting section in the width direction to produce said print of the predetermined size having no margin in the both directions, as well as
resupplying, if the remainder of said uncut recording medium from which said cut recording medium is cut off contains at least one image, said remainder as said uncut recording medium to said first cutting section.

10. The cutting method according to claim 9, wherein said recording medium is cut by said first cutting section into said cut recording medium and said uncut recording medium by cutting said recording medium into the predetermined size in the width direction while matching an image center, which is a center of one image in the width direction, with a cutting center, which is a center of a cutting position in the width direction.

11. The cutting method according to claim 10, wherein said first cutting section cuts said cut recording medium into the predetermined size in the width direction by setting two cutting positions that are spaced apart from each other with respect to a predetermined reference position in the width direction by the same distance and by adjusting the distance between said cutting positions, and matches said cutting center and said image center with each other by adjusting a position of said recording medium in the width direction.

12. A printer comprising:
an image forming section for carrying out image recording by multi-image imposition to record plural images onto one recording medium by distributing said plural images in accordance with sizes of said one recording medium and a print, or image recording by one-image imposition to record an image onto said one recording medium in accordance with said sizes; and
a cutting apparatus including:
conveying means for conveying said one recording medium on which at least one image is recorded;
a cutting section having two cutting means, each cutting means for cutting said one recording medium in a conveying direction by said conveying means into a predetermined size in a width direction orthogonal to the conveying direction, said two cutting means being capable of adjusting a distance between said two cutting means in the width direction; and
position adjusting means for matching a cutting center, which is a central position in the width direction of cutting positions at which cutting is carried out by said two cutting means, and an image center, which is a central position in the width direction of at least one image recorded onto said one recording medium, wherein,
when said image recording is carried out by said multi-image imposition, said image forming section records said plural images onto said one recording medium so that said plural images are arranged in a prescribed order in a conveying direction of said one recording medium by said cutting apparatus.
